(19) United States
(12) Patent Application Publication
(10) Pub. No.: US 2026/0097638 A1
(43) Pub. Date: Apr. 9, 2026

(54) HYBRID DRIVE SYSTEM FOR WORK MACHINE

(71) Applicant: Caterpillar Inc., Peoria, IL (US)

(72) Inventors: John Tanner, Dunlap, IL (US); Kyle Patrick Hewerdine, Chillicothe, IL (US)

(73) Assignee: Caterpillar Inc., Peoria, IL (US)

(21) Appl. No.: 18/910,074

(22) Filed: Oct. 9, 2024

(51) Int. Cl. B60K 6/46; B60K 6/26; B60K 6/40; B60L 7/02; B60L 7/10; B60L 50/61; B60R 16/023

(52) U.S. Cl. CPC B60K 6/46; B60K 6/26; B60K 6/40; B60L 7/02; B60L 7/10; B60L 50/61; B60R 16/023; B60K 2006/268; B60Y 2200/92

(57) ABSTRACT

A hybrid drive system for a work machine includes a drive system. The drive system includes an engine that generates a first energy supply. The drive system also includes a generator mechanically coupled with the engine to drive the generator. The drive system further includes a battery system that generates a second energy supply. The drive system includes a motor generator unit mechanically coupled with the generator to drive the generator. The motor generator unit is driven by the battery system. The hybrid drive system also includes a controller communicably coupled with the drive system. The controller is configured to control the drive system to direct, towards one or more traction motors of the work machine, a portion of at least one of the first energy supply via the generator and the second energy supply via the motor generator unit and the generator.

### TECHNICAL FIELD

The present disclosure relates to a hybrid drive system for a work machine, a supplemental energy system for supplying energy to the work machine, and a method of operating the work machine.

### BACKGROUND

A work machine includes a drive system that provides an operating power supply to traction devices of the work machine. The drive system includes an engine that generates and supplies the operating power supply. The work machine also includes an energy storage system, such as a battery system that supplies power to one or more accessories of the work machine. Existing high power drive systems involve voltage levels that are not compatible with existing energy storage system voltage levels for e.g., 2700 Volts Direct Current (VDC) vs. 1500 VDC. Incorporation of such energy storage systems into an electrical architecture of the high-power drive system requires inclusion of a large direct current (DC) to DC conversion equipment. A hybrid system at this power level would also require similar equipment. Such a conversion equipment may be costly, have inherent inefficiencies, and may also consume a large space on the work machine.

GB2498785A describes a hybrid powertrain for a vehicle comprises a first wheel drive, a second wheel drive, an engine having a crankshaft, a first motor-generator electric unit coupled to the crankshaft, a second motor-generator electric unit coupled to the second wheel drive, and an electrical energy storage device connected to both motor-generator electric units. A manual transmission coupled to the first wheel drive is drivable by the crankshaft via a clutch. An electric actuator is provided for actuating the clutch, and an electronic control unit (ECU) is in communication with the electric actuator. The clutch may provide disconnection of the transmission when the first motor generator is not operating as a motor, according to a mode of the vehicle. The clutch is operated by the ECU, which may take account of a driver's clutch pedal position. The invention provides a hybrid vehicle with automatic mode control and the efficiency and cost advantages of a manual transmission.

### SUMMARY OF THE DISCLOSURE

In an aspect of the present disclosure, a hybrid drive system for a work machine is provided. The hybrid drive system includes a drive system. The drive system includes an engine that generates a first energy supply. The drive system also includes a generator mechanically coupled with the engine to drive the generator. The drive system further includes a battery system that generates a second energy supply. The drive system includes a motor generator unit mechanically coupled with the generator to drive the generator. The motor generator unit is driven by the battery system. The hybrid drive system also includes a controller communicably coupled with the drive system. The controller is configured to control the drive system to direct, towards one or more traction motors of the work machine, a portion of at least one of the first energy supply via the generator and the second energy supply via the motor generator unit and the generator.

In another aspect of the present disclosure, a supplemental energy system for supplying energy to a work machine is provided. The supplemental energy system includes a drive system. The drive system includes a battery system that generates a supplementary energy supply. The drive system includes a motor generator unit electrically coupled with the battery system. The supplemental energy system also includes a controller communicably coupled with the drive system. The controller is configured to control the drive system to direct, towards one or more traction motors of the work machine, a portion of the supplementary energy supply via the motor generator unit.

In yet another aspect of the present disclosure, a method of operating a work machine is provided. The method includes operating an engine of a drive system of the work machine, the engine generates a first energy supply, the drive system including a generator mechanically coupled with the engine to drive the generator and a motor generator unit mechanically coupled with the generator to drive the generator. The method also includes operating a battery system of the drive system of the work machine, the battery system generates a second energy supply, the motor generator unit being driven by the battery system. The method further includes controlling, by a controller of the work machine, the drive system to direct, towards one or more traction motors of the work machine, a portion of at least one of the first energy supply via the generator and the second energy supply via the motor generator unit and the generator.

Other features and aspects of this disclosure will be apparent from the following description and the accompanying drawings.

### BRIEF DESCRIPTION OF THE DRAWINGS

FIG. 1 is a schematic perspective view of an exemplary work machine, according to an example of the present disclosure;

FIG. 2 is a block diagram of a hybrid drive system for the work machine of FIG. 1, according to an example of the present disclosure;

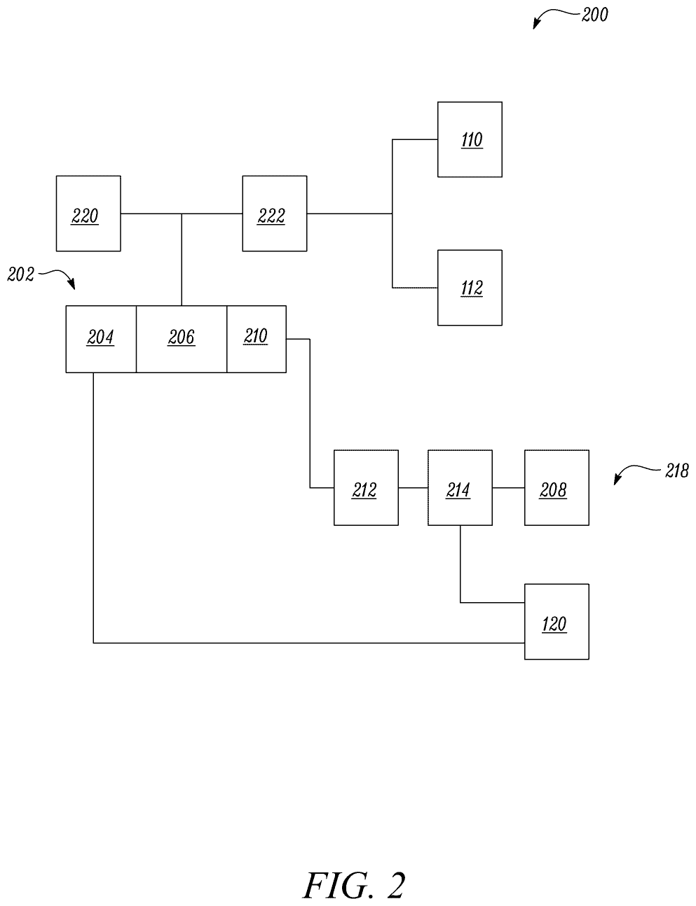

FIG. 3 is a block diagram of the hybrid drive system of FIG. 2; and

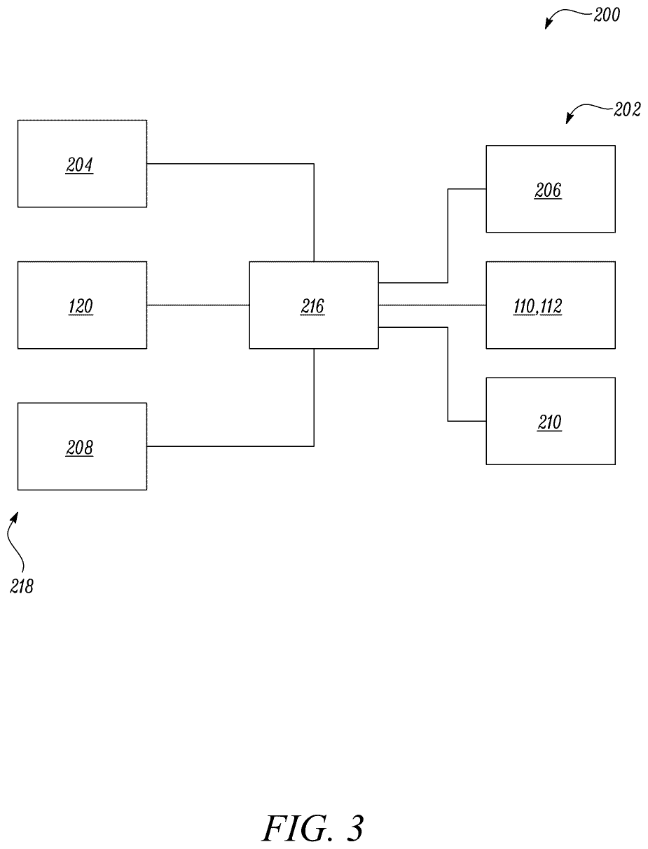

FIG. 4 is a flowchart for a method of operating the work machine of FIG. 1, according to an example of the present disclosure.

### DETAILED DESCRIPTION

Wherever possible, the same reference numbers will be used throughout the drawings to refer to the same or like parts.

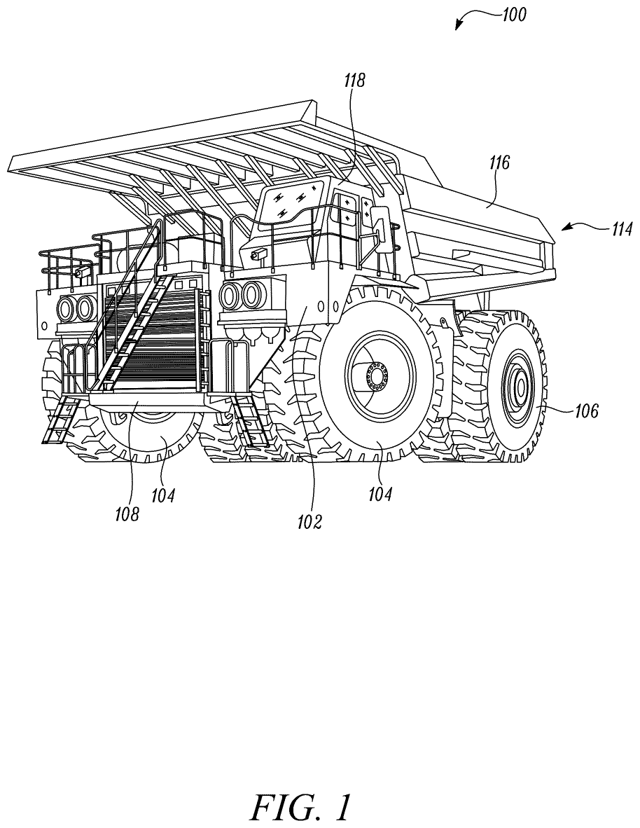

Referring to FIG. 1, a schematic perspective view of a work machine 100 is illustrated. The work machine 100 is embodied as a mining truck that may be used to move a payload, such as asphalt, debris, dirt, snow, feed, gravel, logs, raw minerals, recycled material, rock, sand, woodchips, etc. from one location to another location. Alternatively, the work machine 100 may be an excavator, a dozer, a wheel loader, a track-type tractor, a motor grader, etc. that may be used for various purposes, such as excavation, construction, landscaping, and the like, in various industries.

The work machine 100 includes a chassis 102. The chassis 102 supports a pair of front traction devices 104 and a pair of rear traction devices 106 of the work machine 100. The front traction devices 104 and the rear traction devices 106 are embodied as wheels herein. The work machine 100 also includes an enclosure 108. The work machine 100 includes one or more traction motors 110, 112 that are operatively coupled to respective traction devices 104, 106 to operate the traction devices 104, 106.

The work machine 100 further includes a dump body 114. The dump body 114 includes a box portion 116. The box portion 116 of the dump body 114 holds the payload. The work machine 100 also includes an operator cabin 118 mounted to the chassis 102. The operator cabin 118 may include one or more controls (not shown) that may enable an operator to control the work machine 100.

The work machine 100 further includes one or more machine systems 120. The one or more machine systems 120 may include one or more of a thermal management system of the work machine 100, a heat, ventilation, and air conditioning (HVAC) system of the work machine 100, and a hydraulic system of the work machine 100. The thermal management system may be used, for example, to cool different components of the work machine 100. The one or more machine systems 120 may also include a lighting system of the work machine 100. It should be noted that the one or more machine systems 120 may include any accessory, components, or combination of components that are associated/disposed in the work machine 100 and may require power supply to operate.

The present disclosure relates to a hybrid drive system 200 for the work machine 100. The hybrid drive system 200 includes a drive system 202. The drive system 202 includes an engine 204 that generates a first energy supply. The engine 204 includes, for e.g., an internal combustion engine that provides power to various components of the work machine 100 for operational and mobility requirements. The enclosure 108 houses the engine 204. The drive system 202 also includes a generator 206 mechanically coupled with the engine 204 to drive the generator 206. In an example, the generator 206 may include a synchronous alternator. Alternatively, the generator 206 may include any electric machine known in the art.

The drive system 202 further includes a battery system 208 that generates a second energy supply. The battery system 208 provides power supply to the one or more components of the work machine 100. The drive system 202 further includes a motor generator unit 210 mechanically coupled with the generator 206 to drive the generator 206. The motor generator unit 210 is driven by the battery system 208. In an example, the motor generator unit 210 may include an internal permanent magnet type motor generator unit. Alternatively, the motor generator unit 210 may include any electric machine known in the art.

The drive system 202 further includes an inverter 212 disposed between the battery system 208 and the motor generator unit 210. The drive system 202 further includes a power distribution unit 214 disposed between the inverter 212 and the battery system 208. The power distribution unit 214 is electrically coupled with various components of the work machine 100, such as, the machine systems 120. The power distribution unit 214 receives power supply from the battery system 208 and transmits a portion of the power supply to the machine systems 120 to operate the machine systems 120.

The hybrid drive system 200 further includes a controller 216 communicably coupled with the drive system 202. The controller 216 controls the drive system 202 to direct, towards the one or more traction motors 110, 112 of the work machine 100, a portion of the first energy supply via the generator 206 and/or the second energy supply via the motor generator unit 210 and the generator 206.

In an example, the controller 216 may control the drive system 202 to direct some portion of the first energy supply via the generator 206 towards the one or more traction motors 110, 112. In one example, if the engine 204 is operating in an optimal region and a state of charge of the battery system 208 is low, then the controller 216 may control the drive system 202 to direct some portion of the first energy supply towards the one or more traction motors 110, 112. In another example, if the operating load on the engine 204 is low and the state of charge of the battery system 208 is low, then the controller 216 may control the drive system 202 to direct some portion of the first energy supply towards the one or more traction motors 110, 112.

In another example, the controller 216 may control the drive system 202 to direct some portion of the second energy supply via the motor generator unit 210 and the generator 206 towards the one or more traction motors 110, 112. For example, if the operating load on the engine 204 is high and the state of charge of the battery system 208 is high, then the controller 216 may control the drive system 202 to direct some portion of the second energy supply towards the one or more traction motors 110, 112. In some examples, some portion of the second energy supply from the battery system 208 may be used to operate the traction motors 110, 112 in order to move the work machine 100 by small distances without starting the engine 204.

In some examples, the controller 216 may control the drive system 202 to direct some portion of the first energy supply via the generator 206 as well as some portion of the second energy supply via the motor generator unit 210 and the generator 206. For example, 60% of power being received by the traction motors 110, 112 may be received from the engine 204 and 40% of power being received by the traction motors 110, 112 may be received from the battery system 208. Further, the combination of the first and second energy supply may be used to provide a power boost to the work machine 100, in conditions, such as, on grade, on pull-away, or throttle tip in.

In some examples, the drive system 202, including the battery system 208 and the motor generator unit 210, and the controller 216 together form a part of a supplemental energy system 218 for supplying energy to the work machine 100. In other words, the supplemental energy system 218 includes the drive system 202 and the controller 216.

The drive system 202 further includes a grid 220. The grid 220 is embodied as an energy dissipator that dissipates excess energy from the traction motors 110, 112. The drive system 202 further includes a traction inverter 222 disposed between the generator 206 and the one or more traction motors 110, 112. The traction inverter 222 receives the first and second energy supply from the generator 206. Further, the traction inverter 222 converts the first and second energy supply from alternating current to direct current (DC), and then supplies the converted energy supply to the traction motors 110, 112.

In some examples, the controller 216 determines one or more of an availability of power at the battery system 208, an operating state of the engine 204, an operating load on the engine 204, an operating state of the work machine 100, one or more functions to be performed by the work machine 100, and a requirement of the one or more machine systems 120 of the work machine 100 to direct the portion of the first energy supply and/or the second energy supply towards the one or more traction motors 110, 112. The availability of power at the battery system 208 may include the state of charge of the battery system 208, a health of the battery system 208, or any other factor that may contribute to the availability of power at the battery system 208. The operating state of the engine 204 may include, for example, the operation of the engine 204 in an idling state.

In some examples, the controller 216 may receive an operator input from the operator of the work machine 100 to direct the portion of the first energy supply and/or the second energy supply towards the one or more traction motors 110, 112. It should be noted that the controller 216 may receive any number of inputs from different systems of the work machine 100 to control the drive system 202 for directing the portion of the first energy supply and/or the second energy supply towards the one or more traction motors 110, 112. It should be further noted that, for controlling the drive system 202, the controller 216 may control one or more of the engine 204, the battery system 208, the motor generator unit 210, and/or the generator 206.

The controller 216 may include one or more processors and one or more memories in communication with the one or more processors. The one or more memories may include any means of storing information, including a hard disk, an optical disk, a floppy disk, ROM (read only memory), RAM (random access memory), PROM (programmable ROM), EEPROM (electrically erasable PROM), or other computer-readable memory media. It should be noted that the one or more processors may embody a single microprocessor or multiple microprocessors for receiving various input signals and generating output signals. Numerous commercially available microprocessors may perform the functions of the processors. The one or more processors may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors may include one or more components that may be operable to execute computer executable instructions or computer code that may be stored and retrieved from the one or more memories.

In an example, the controller 216 controls the drive system 202 to direct a regenerative energy supply from the one or more traction motors 110, 112 towards the battery system 208 via the generator 206 and the motor generator unit 210. The regenerative energy supply may allow charging of the battery system 208.

In another example, the controller 216 controls the drive system 202 to direct an energy supply from the engine 204 towards the battery system 208 via the generator 206 and the motor generator unit 210 to charge the battery system 208. Specifically, if the operating load on the engine 204 is low and the state of charge of the battery system 208 is low, the controller 216 may control the drive system 202 to direct the energy supply from the engine 204 towards the battery system 208 to charge the battery system 208. In yet another example, the controller 216 controls the traction inverter 222 to dissipate energy from the one or more traction motors 110, 112 to the grid 220 via the traction inverter 222.

In an example, the controller 216 controls the drive system 202 to direct an energy supply from the battery system 208 towards the engine 204 via the motor generator unit 210 and the generator 206 to crank the engine 204. For example, in situations of low machine power demand and high state of charge of the battery system 208, the second energy supply may be directed towards the engine 204 to start the engine 204.

In another example, the controller 216 controls the drive system 202 to direct, towards the one or more machine systems 120, a portion of the first energy supply via the generator 206 and/or the second energy supply via the motor generator unit 210 and the generator 206. For example, if the operating load on the engine 204 is high and the state of charge of the battery system 208 is high, the controller 216 may control the drive system 202 to direct some portion of the second energy supply towards the one or more machine systems 120. Specifically, in times of high machine power demand, the controller 216 may control the drive system 202 to direct some portion of the second energy supply towards the one or more machine systems 120 to maintain machine performance, to decrease the operating load on the engine 204, and to operate the engine 204 in the optimal region. In some examples, the battery system 208 may supply the second energy supply to the machine systems 120, while the engine 204 is off.

Further, if the operating load on the engine 204 is optimal or at a lower side and the state of charge of the battery system 208 is low, the controller 216 may control the drive system 202 to direct some portion of the first energy supply towards the one or more machine systems 120. For example, in situations of low machine power demand, the first energy supply will be directed to the traction motors 110, 112 to increase the operating load on the engine 204 to maintain operation of the engine 204 in the optimal region. In yet another example, the controller 216 may control the drive system 202 to direct an energy supply from the traction motors 110, 112 to the engine 204, via the generator 206.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the hybrid drive system 200 for the work machine 100. The drive system 202 includes the engine 204, the generator 206 driven by the engine 204, and the motor generator unit 210 that is powered by the battery system 208. The incorporation of the motor generator unit 210 provides two separate electric links on the work machine 100 and allows power supply to flow between the two electrically separate systems through the generator 206. This allows power to be provided to the generator 206 for the traction motors 110, 112 from both the engine 204 and the battery system 208. The incorporation of the motor generator unit 210 allows powering of the traction motors 110, 112 with the first energy supply from the engine 204 and/or the second energy supply from the battery system 208 without the need of large equipment for DC-to-DC conversion.

The incorporation of the motor generator unit 210 may allow reduction of a size of the engine 204 as supplemental power supply can be supplied by the battery system 208. Moreover, a braking of the work machine 100 may be improved as both the engine 204 and the battery system 208 can serve as sinks. The controller 216 of the hybrid drive system 200 is programmed to co-ordinate with all components of the drive system 202 to achieve optimal results.

In one example, during auto start or auto stop, during idling conditions, based on certain machine conditions, or based on operator inputs, the engine 204 may be turned off and the traction motors 110, 112 may be supplied with the second energy supply from the battery system 208.

In another example, the hybrid drive system 200 may be used to crank the engine 204 which may reduce wear and tear on an engine starter of the work machine 100 and may also increase opportunities for engine idle reduction (auto start/auto stop).

In yet another example, when sudden load is added to the machine systems 120 or if the operating load on the engine 204 increases, the incorporation of the motor generator unit 210 may minimize a performance delay while waiting for the engine 204 to spool up, as the second energy supply may be directed to the machine systems 120 or the traction motors 110, 112.

In some examples, the motor generator unit 210 and the battery system 208 may be used to supply the second energy supply to the machine systems 120 or the traction motors 110, 112 in times of high machine power demand to decrease the operating load on the engine 204 in order to maintain engine 204 operation in the optimal region. Further, the motor generator unit 210 may be used to supply the first energy supply to the battery system 208 to charge the battery system 208 for later usage in times of low machine power demand to increase the operating load on the engine 204 in order to maintain engine 204 operation in the optimal region. Furthermore, the motor generator unit 210 may allow peak shave in times of high machine power demand to maintain machine performance, to decrease the operating load on the engine 204, and to maintain the operation of the engine 204 in the optimal region.

Further, incorporation of the motor generator unit 210 may allow increased dynamic auto-retarding based on the state of charge of the battery system 208 and the requirement of other machine systems 120. Moreover, energy supply can also flow from the traction motors 110, 112 to the generator 206 and then to the motor generator unit 210, and back to the battery system 208, thereby enabling regenerative braking.

In some cases, the motor generator unit 210 and the battery system 208 may be used to power the machine systems 120 while the engine 204 is off and may also be used to move the work machine 100 by small distances without starting the engine 204. Moreover, the motor generator unit 210 may be used to provide a power boost in certain scenarios, such as, on grade, on pull-away, during throttle tip in, and the like.

FIG. 8 is the flowchart for a method 400 of operating the work machine 100. At step 402, the engine 204 of the drive system 202 of the work machine 100 is operated. The engine 204 generates the first energy supply. The drive system 202 includes the generator 206 mechanically coupled with the engine 204 to drive the generator 206 and the motor generator unit 210 mechanically coupled with the generator 206 to drive the generator 206.

At step 404, the battery system 208 of the drive system 202 of the work machine 100 is operated. The battery system 208 generates the second energy supply, the motor generator unit 210 being driven by the battery system 208.

At step 406, the controller 216 of the work machine 100 controls the drive system 202 to direct, towards the one or more traction motors 110, 112 of the work machine 100, the portion of the first energy supply via the generator 206 and/or the second energy supply via the motor generator unit 210 and the generator 206.

In some examples, the method 400 further includes a step (not shown) at which the controller 216 controls the drive system 202 to direct the regenerative energy supply from the one or more traction motors 110, 112 towards the battery system 208 via the generator 206 and the motor generator unit 210.

In some examples, the method 400 further includes a step (not shown) at which the controller 216 controls the drive system 202 to direct the energy supply from the engine 204 towards the battery system 208 via the generator 206 and the motor generator unit 210 to charge the battery system 208.

The drive system 202 further includes the grid 220, and the traction inverter 222 disposed between the generator 206 and the one or more traction motors 110, 112. The method 400 further includes a step (not shown) at which the traction inverter 222 is controlled to dissipate energy from the one or more traction motors 110, 112 to the grid 220 via the traction inverter 222.

In some examples, the method 400 further includes a step (not shown) at which the controller 216 determines one or more of the availability of power at the battery system 208, the operating state of the engine 204, the operating load on the engine 204, the operating state of the work machine 100, and one or more functions to be performed by the work machine 100, and the requirement of the one or more machine systems 120 of the work machine 100 to direct the portion of the first energy supply and/or the second energy supply towards the one or more traction motors 110, 112.

In some examples, the method 400 further includes a step (not shown) at which the controller 216 controls the drive system 202 to direct the energy supply from the battery system 208 towards the engine 204 via the motor generator unit 210 and the generator 206 to crank the engine 204.

The work machine 100 further includes the one or more machine systems 120. The one or more machine systems 120 include one or more of the thermal management system of the work machine 100, the HVAC system of the work machine 100, and the hydraulic system of the work machine 100, In some examples, the method 400 further includes a step (not shown) at which the controller 216 controls the drive system 202 to direct, towards the one or more machine systems 120, the portion of the first energy supply via the generator 206 and/or the second energy supply via the motor generator unit 210 and the generator 206.

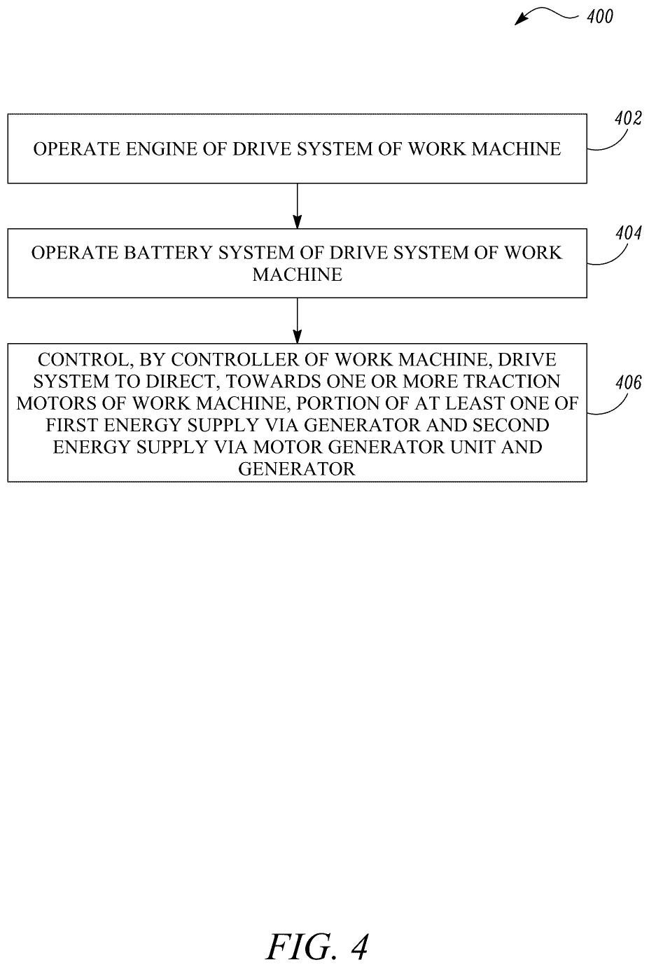

It should be noted that the steps 402, 404, 406 of the method 400 may be performed in a sequence that is different from that explained in relation to FIG. 4. Further, various steps 202, 204, 206 can be performed together.

While aspects of the present disclosure have been particularly shown and described with reference to the embodiments above, it will be understood by those skilled in the art that various additional embodiments may be contemplated by the modification of the disclosed work machines, systems, and methods without departing from the spirit and scope of the disclosure. Such embodiments should be understood to fall within the scope of the present disclosure as determined based upon the claims and any equivalents thereof.

What is claimed is:

1. A hybrid drive system for a work machine, the hybrid drive system comprising:
a drive system including:
an engine that generates a first energy supply;
a generator mechanically coupled with the engine to drive the generator;
a battery system that generates a second energy supply; and
a motor generator unit mechanically coupled with the generator to drive the generator, wherein the motor generator unit is driven by the battery system; and
a controller communicably coupled with the drive system, wherein the controller is configured to control the drive system to direct, towards one or more traction motors of the work machine, a portion of at least one of the first energy supply via the generator and the second energy supply via the motor generator unit and the generator.

2. The hybrid drive system of claim 1, wherein the controller is further configured to control the drive system to direct:
a regenerative energy supply from the one or more traction motors towards the battery system via the generator and the motor generator unit; or
an energy supply from the engine towards the battery system via the generator and the motor generator unit to charge the battery system.

3. The hybrid drive system of claim 1, wherein the drive system further includes a grid, and a traction inverter disposed between the generator and the one or more traction motors, and wherein the controller is further configured to control the traction inverter to dissipate energy from the one or more traction motors to the grid via the traction inverter.

4. The hybrid drive system of claim 1, wherein the controller is configured to determine one or more of an availability of power at the battery system, an operating state of the engine, an operating load on the engine, an operating state of the work machine, one or more functions to be performed by the work machine, and a requirement of one or more machine systems of the work machine to direct the portion of at least one of the first energy supply and the second energy supply towards the one or more traction motors.

5. The hybrid drive system of claim 1, wherein the drive system further includes an inverter disposed between the battery system and the motor generator unit.

6. The hybrid drive system of claim 1, wherein the controller is further configured to control the drive system to direct an energy supply from the battery system towards the engine via the motor generator unit and the generator to crank the engine.

7. The hybrid drive system of claim 1, wherein the work machine further includes one or more machine systems, wherein the one or more machine systems include one or more of a thermal management system of the work machine, a heat, ventilation, and air conditioning system of the work machine, and a hydraulic system of the work machine, and wherein the controller is further configured to control the drive system to direct, towards the one or more machine systems, a portion of at least one of the first energy supply via the generator and the second energy supply via the motor generator unit and the generator.

8. A supplemental energy system for supplying energy to a work machine, the supplemental energy system comprising:
a drive system including:
a battery system that generates a supplementary energy supply; and
a motor generator unit electrically coupled with the battery system; and
a controller communicably coupled with the drive system, wherein the controller is configured to control the drive system to direct, towards one or more traction motors of the work machine, a portion of the supplementary energy supply via the motor generator unit.

9. The supplemental energy system of claim 8, wherein the controller is further configured to control the drive system to direct:
a regenerative energy supply from the one or more traction motors towards the battery system via a generator of the drive system and the motor generator unit; or
an energy supply from an engine of the drive system towards the battery system via the generator and the motor generator unit to charge the battery system.

10. The supplemental energy system of claim 8, wherein the drive system further includes a grid, and a traction inverter disposed between a generator of the drive system and the one or more traction motors, and wherein the controller is further configured to control the traction inverter to dissipate energy from the one or more traction motors to the grid via the traction inverter.

11. The supplemental energy system of claim 8, wherein the controller is further configured to control the drive system to direct an energy supply from an engine of the drive system towards the battery system via a generator of the drive system and the motor generator unit to charge the battery system.

12. The supplemental energy system of claim 8, wherein the controller is configured to determine one or more of an availability of power at the battery system, an operating state of an engine of the drive system, an operating state of the work machine, one or more functions to be performed by the work machine, and a requirement of one or more machine systems of the work machine to direct the portion of the supplementary energy supply towards the one or more traction motors.

13. The supplemental energy system of claim 8, wherein the controller is further configured to control the drive system to direct an energy supply from the battery system towards an engine of the drive system via the motor generator unit and a generator of the drive system to crank the engine.

14. The supplemental energy system of claim 8, wherein the work machine further includes one or more machine systems, wherein the one or more machine systems include one or more of a thermal management system of the work machine, a heat, ventilation, and air conditioning system of the work machine, and a hydraulic system of the work machine, and wherein the controller is further configured to control the drive system to direct, towards the one or more traction motors of the work machine, the portion of the supplementary energy supply via the motor generator unit.

15. A method of operating a work machine, the method comprising:
operating an engine of a drive system of the work machine, the engine generates a first energy supply, the drive system including a generator mechanically coupled with the engine to drive the generator and a motor generator unit mechanically coupled with the generator to drive the generator;
operating a battery system of the drive system of the work machine, the battery system generates a second energy supply, the motor generator unit being driven by the battery system; and
controlling, by a controller of the work machine, the drive system to direct, towards one or more traction motors of the work machine, a portion of at least one of the first energy supply via the generator and the second energy supply via the motor generator unit and the generator.

16. The method of claim 15 further comprising controlling, by the controller, the drive system to:
a regenerative energy supply from the one or more traction motors towards the battery system via the generator and the motor generator unit; or
an energy supply from the engine towards the battery system via the generator and the motor generator unit to charge the battery system.

17. The method of claim 15, wherein the drive system further includes a grid, and a traction inverter disposed between the generator and the one or more traction motors, the method further comprising controlling the traction inverter to dissipate energy from the one or more traction motors to the grid via the traction inverter.

18. The method of claim 15 further comprising determining, by the controller, one or more of an availability of power at the battery system, an operating state of the engine, an operating load on the engine, an operating state of the work machine, and one or more functions to be performed by the work machine, and a requirement of one or more machine systems of the work machine to direct the portion of at least one of the first energy supply and the second energy supply towards the one or more traction motors.

19. The method of claim 15 further comprising controlling, by the controller, the drive system to direct an energy supply from the battery system towards the engine via the motor generator unit and the generator to crank the engine.

20. The method of claim 15, wherein the work machine further includes one or more machine systems, and wherein the one or more machine systems include one or more of a thermal management system of the work machine, a heat, ventilation, and air conditioning system of the work machine, and a hydraulic system of the work machine, the method further comprising controlling, by the controller, the drive system to direct, towards the one or more machine systems, a portion of at least one of the first energy supply via the generator and the second energy supply via the motor generator unit and the generator.
